(19) United States
(12) Patent Application Publication
(10) Pub. No.: US 2025/0240641 A1
(43) Pub. Date: Jul. 24, 2025

(54) DETERMINING COVERAGE AREA OVERLAP OF BASE STATIONS IN PROXIMITY TO ONE ANOTHER

(71) Applicant: Charter Communications Operating, LLC, St. Louis, MO (US)

(72) Inventor: Pareshkumar Panchal, Highlands Ranch, CO (US)

(21) Appl. No.: 18/417,436

(22) Filed: Jan. 19, 2024

(51) Int. Cl. H04W 16/18; H04W 16/28

(52) U.S. Cl. CPC H04W 16/18; H04W 16/28

(57) ABSTRACT

For each respective base station of a plurality of base stations, a coverage area of the respective base station is determined. For at least some respective base stations of the plurality of base stations, a coverage area overlapped quantity is determined that quantifies for a respective base station an overlap region of the coverage area of the respective base station that is overlapped by a coverage area of another base station of the plurality of base stations. A coverage area overlap (CAO) structure is generated that identifies for each respective base station of the at least some respective base stations, the coverage area overlapped quantity of the respective base station and an identifier of the base station that has the coverage area that overlaps the coverage area of the respective base station.

### BACKGROUND

A wireless service provider typically installs a network of base stations to provide coverage in a relatively large geographic area. Typically, there will be coverage area overlap between base stations in relative close proximity to one another, and there are also typically at least some areas that may not be covered. The coverage area of base stations may differ based on a number of different factors, such as an azimuth of the antenna, a beamwidth of the antenna, an electronic or manual tilt of the antenna, the height of the antenna, frequency of transmission, and the like.

### SUMMARY

The examples disclosed herein determine coverage area overlap of base stations in proximity to one another.

In one implementation a method is provided. The method includes determining, by a computing system comprising one or more computing devices, for each respective base station of a plurality of base stations, a coverage area of the respective base station. The method further includes, for at least some respective base stations of the plurality of base stations determining, by the computing system, a coverage area overlapped quantity that quantifies for a respective base station an overlap region of the coverage area of the respective base station that is overlapped by a coverage area of another base station of the plurality of base stations. The method further includes generating, by the computing system, a coverage area overlap (CAO) structure that identifies for each respective base station of the at least some respective base stations, the coverage area overlapped quantity of the respective base station and an identifier of the base station that has the coverage area that overlaps the coverage area of the respective base station.

In another implementation a computing system is provided. The computing system includes one or more computing devices operable to determine, for each respective base station of a plurality of base stations, a coverage area of the respective base station. The one or more computing devices are further operable to, for at least some respective base stations of the plurality of base stations determine a coverage area overlapped quantity that quantifies for a respective base station an overlap region of the coverage area of the respective base station that is overlapped by a coverage area of another base station of the plurality of base stations. The one or more computing devices are further operable to generate a coverage area overlap (CAO) structure that identifies for each respective base station of the at least some respective base stations, the coverage area overlapped quantity of the respective base station and an identifier of the base station that has the coverage area that overlaps the coverage area of the respective base station.

In another implementation a non-transitory computer-readable storage medium is provided. The non-transitory computer-readable storage medium includes executable instructions to cause one or more computing devices to determine, for each respective base station of a plurality of base stations, a coverage area of the respective base station. The instructions further cause the one or more computing devices to, for at least some respective base stations of the plurality of base stations determine a coverage area overlapped quantity that quantifies for a respective base station an overlap region of the coverage area of the respective base station that is overlapped by a coverage area of another base station of the plurality of base stations. The instructions further cause the one or more computing devices to generate a coverage area overlap (CAO) structure that identifies for each respective base station of the at least some respective base stations, the coverage area overlapped quantity of the respective base station and an identifier of the base station that has the coverage area that overlaps the coverage area of the respective base station.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which determining coverage area overlap of base stations in proximity to one another can be practiced according to some implementations;

FIG. 2 is a flowchart of a method for determining coverage area overlap of base stations in proximity to one another according to one implementation;

FIG. 3 is a block diagram illustrating a visualization based on a coverage area overlap (CAO) structure according to one example;

FIG. 4 is a block diagram illustrating a visualization based on the CAO structure according to another example;

FIG. 5 is a flowchart of a method for reducing energy costs in the environment illustrated in FIG. 1 based on the CAO structure according to one implementation;

FIGS. 6A-6B are block diagrams of the environment illustrated in FIG. 1 illustrating the addition of a new base station that implements three coverage areas;

FIG. 7 is a flowchart of a method for determining, based on the CAO structure, a location of a new base station to provide coverage in an uncovered area in the environment illustrated in FIG. 1 according to one implementation;

FIG. 8 is a block diagram of a computing device suitable for implementing examples according to one example; and

FIG. 9 is a flowchart of a method for identifying preferable timeframes to power down a base station based on overlapping coverage areas and utilization metrics of the overlapping coverage areas according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As used herein, the term “base station” refers to a system that includes an antenna, or multiple antenna, and one or more computing devices, at least one of which is coupled to the antenna and capable of transmitting and receiving signals via the antenna. The antenna may be integrated into a same frame or housing as the computing device or may be standalone and communicatively coupled to the computing device via a communications medium, such as a fiber or wired communications medium. The base station may comprise a cellular base station such as a 4G, 5G or other type of cellular base station. Alternatively the base station may comprise a mesh network base station.

The term “coverage area” as used herein refers to the geographic area within which a device, such as a mobile phone, can be serviced by a base station. The term “cell” may sometimes be used as a synonym for “coverage area”. A service provider typically installs a network of base stations to provide coverage in a relatively large geographic area. Typically there will be coverage area overlap between base stations in relative close proximity to one another, and there are also typically at least some areas that may not be covered. The coverage area of base stations may differ based on a number of different factors, such as an azimuth of the antenna, a beamwidth of the antenna, an electronic or manual tilt of the antenna, the height of the antenna, and the like. Typically the extent of coverage overlap is unknown. However, there are many circumstances in which it would be helpful to know with some degree of accuracy the coverage overlap between base stations so that decisions may be made that may temporarily impact a base station's coverage area, such as might occur when a problem with a base station is being diagnosed, or when a base station is upgraded, or the like. Knowledge of the coverage area overlap may also be useful in determining whether the capital expenditure of a new base station is worthwhile. Knowledge of the coverage area overlap may also be useful in reducing resources under certain circumstances where, for example, a coverage area of a base station is sufficiently overlapped by one or more other base stations that the base station coverage area may be powered off during certain low utilization times with little to no negative impact to users.

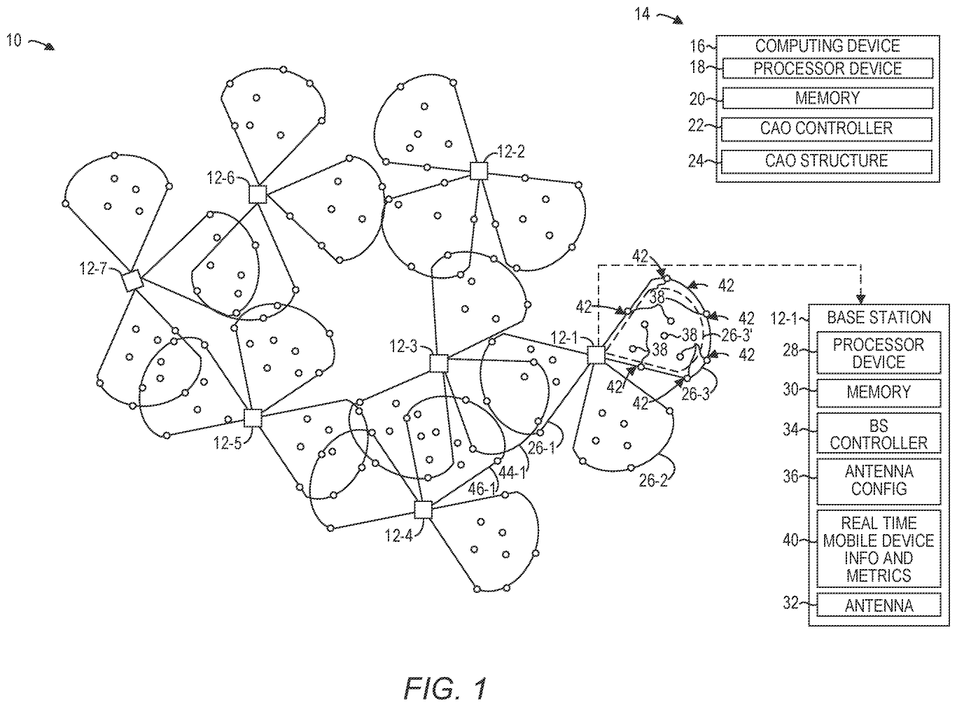

FIG. 1 is a block diagram of an environment 10 in which determining coverage area overlap of base stations in proximity to one another can be practiced according to some implementations. The environment 10 includes a plurality of base stations 12-1-12-7 (generally, base stations 12). In these examples the base stations 12 are multi-sector base stations and implement three coverage areas each, however, the examples disclosed herein are not limited to multi-sector base stations and apply equally to single-sector base stations. The base stations 12 may comprise any suitable wireless base station, such as a 5G base station, a 4G base station, a 3G base station or the like. In some implementations the base stations may implement Citizens Broadband Radio Service (CBRS), which is a 150 MHz wide broadcast band of the 3.5 GHZ band (3550 MHz to 3700 MHZ) in the United States. In such implementations, the base stations 12 may comprise Citizens Broadband Radio Service Devices (CBSDs), such as an Evolved NodeB (eNodeB) or gNodeB (sometimes referred to as gNB) by way of non-limiting example. The examples disclosed herein may also be applied to wireless frequencies defined by standard (FR1: <6 GHz or FR2: >6 GHz). While only seven base stations 12 are illustrated, in practice, the environment 10 could have tens, hundreds or thousands of base stations 12.

The environment 10 also includes a computing system 14 that includes one or more computing devices 16. The computing device 16 includes a processor device 18 and a memory 20. A coverage area overlap (CAO) controller 22 executes on the computing system 14 and, as will be discussed in greater detail below, may receive information from each of the base stations 12 to determine the coverage area overlap of the base stations 12. The CAO controller 22 may store such information in one or more data structures, such as, by way of non-limiting example, a CAO structure 24.

The base station 12-1 implements three coverage areas 26-1-26-3. The base station 12-1 includes a processor device 28, a memory 30, and one or more antennas 32. The base station 12-1 also includes a base station (BS) controller 34 which, as will be discussed in greater detail herein, periodically, intermittently, or upon the occurrence of some event, provides information to the CAO controller 22. The base station 12-1 may include antenna configuration information 36 that contains a current configuration of the antennas 32, such as, by way of non-limiting example, a location of the antennas 32, a height of the antennas 32, an azimuth of the antennas 32, a tilt of the antennas 32, a physical cell ID (PCI) of each coverage area 26, frequencies used by the antennas 32, and the like. In this example, the coverage area 26-3 is providing service to a plurality of mobile devices 38. For each mobile device 38 the base station 12-1 may maintain real time mobile device information and metrics 40. The real time mobile device information and metrics 40 may include, for each respective mobile device 38, a location identifier that identifies a location of the respective mobile device 38, an average power received from a single reference signal (RSRP) of the respective mobile device 38, a signal to noise ratio (SINR) of the respective mobile device 38, and the like. The base stations 12-2-12-7 may be configured substantially similarly to the base station 12-1, and maintain identical or substantially similar information for each antenna and each mobile device serviced by the respective base station 12. While for purposes of illustration each of the coverage areas illustrated in FIG. 1 have a substantially similar shape, in practice, the shapes of the coverage areas may differ substantially from one another.

With this background, an example of determining coverage area overlap of base stations in proximity to one another will be discussed. The CAO controller 22 determines, for each of the base stations 12, a coverage area of the base stations 12. In this example, the computing system 14 will determine three coverage areas for each of the base stations 12 since, in this example, each of the base stations 12 is a multi-sector base station that generates three separate coverage areas. However, in practice, the base stations 12 may have fewer than three coverage areas or more than three coverage areas, and the base stations 12 may have different numbers of coverage areas.

In one implementation, the CAO controller 22 determines the coverage areas by receiving coverage area information from each of the base stations 12. The coverage area information may be provided to the CAO controller 22 at some periodic interval, such as every 10 minutes, 15 minutes, or the like. In some implementations, the CAO controller 22 may periodically request the coverage area information from the base stations 12 at some periodic interval, such as every 10 minutes, 15 minutes, or the like.

The coverage area information may include, by way of non-limiting example, location information that identifies a location of the respective base station 12, azimuth information that identifies an azimuth of the antenna(s) of the base station 12, beamwidth information that identifies a beamwidth of the antenna(s) of the base station 12, tilt information that identifies a tilt of the antenna(s) of the base station 12. If the base station 12 is currently servicing static or mobile devices, the coverage area information may also include device location information that identifies a plurality of locations of devices being serviced by the base station 12. In some implementations, the base stations 12 themselves may determine the coverage areas, and provide to the CAO controller 22 information that identifies the perimeter of the coverage areas, such as GPS coordinates of the perimeters of the coverage areas.

The CAO controller 22, based on the coverage area information, determines the coverage area(s) of each of the base stations 12. The CAO controller 22 may determine the coverage area based solely on characteristics of the antenna, such as the location of the antenna, the azimuth information, the beam width information, and/or the tilt information. Where the base station 12 is actively servicing one or more mobile devices in a coverage area, the CAO controller 22 may also utilize information associated with the mobile devices, such as the location of each mobile device. The CAO controller 22 may store information that identifies the coverage area of each base station 12 in the CAO structure 24. The information may comprise, for example, a series of GPS locations or other location identifiers that define the perimeter of the coverage area(s).

As an example of determining the coverage area 26-3 of the base station 12-1, the CAO controller 22 receives, from the base station 12-1, coverage area information for the coverage area 26-3 that includes the antenna configuration information 36 and the real time mobile device information and metrics 40 for each of the mobile devices 38 currently being serviced by the base station 12-1 in the coverage area 26-3. The CAO controller 22 utilizes the location of the antenna(s) 32 responsible for implementing the coverage area 26-3, a height of the antenna(s) 32, an azimuth of the antenna(s) 32, and a tilt of the antenna(s) 32. Based on this information, the CAO controller 22 may determine an initial coverage area 26-3′, illustrated in dashed outline in FIG. 1. The CAO controller 22 may then access the real time mobile device information and metrics 40 and based on the locations of the mobile devices 38 derive a coverage area 26-3, illustrated in solid outline in FIG. 1.

The CAO controller 22 may store information in the CAO structure 24 that defines the perimeter of the coverage area 26-3, along with the physical cell ID of the coverage area 26-3, and any or all of the antenna configuration information 36 and the real time mobile device information and metrics 40. The CAO controller 22 may also store a timestamp identifying the date and time that the coverage area 26-3 was determined. This process may be repeated over time, such as every 15 minutes, or any other suitable interval. In some implementations, a quantity of historical coverage area determinations may be stored for each coverage area, and the newest coverage area determination may be combined with a predetermined number of the most recent previous coverage area determinations to determine the current coverage area. For example, the CAO controller 22 may maintain five coverage area determinations for the coverage area 26-3, and each time a new coverage area is determined the new coverage area determination may be averaged (or otherwise combined) with the previous five coverage area determinations to determine a final new coverage area. A coverage area may be defined in any suitable manner that allows the CAO controller 22 to determine if one coverage area overlaps another coverage area. In some implementations, a perimeter of the coverage area may be identified based on GPS coordinates. For example, based on the antenna configuration information 36 and the real time mobile device information and metrics 40, the CAO controller 22 may determine the GPS coordinates at a plurality of locations 42, and store such locations as defining the perimeter of the coverage area 26-3.

The CAO controller 22 may also store, in the CAO structure 24, information regarding the quantity of mobile devices being serviced in a coverage area at various times. For example, the CAO controller 22 may, for each hour of the day, maintain an average of the mobile devices 38 being serviced by the base station 12-1 in the coverage area 26-3 so that it can subsequently be determined how busy the base station 12-1 is servicing mobile devices 38 in the coverage area 26-3 at any particular time of day. This information may also be maintained on a day of the week basis.

The CAO controller 22 performs the process described above to determine the coverage areas for each of the base stations 12, and stores such information in the CAO structure 24. The CAO controller 22 may then determine the coverage area overlap of coverage areas with one another. The CAO controller 22 may iterate through each coverage area and determine which other coverage areas overlap the coverage area, a location of such overlap, and a coverage area overlapped quantity. For example, the CAO controller 22 may start with the coverage area 26-3 and determine that no other coverage area overlaps the coverage area 26-3.

The CAO controller 22 may next process the coverage area 26-2 and determine that no other coverage area overlaps the coverage area 26-2. The CAO controller 22 may next process the coverage area 26-1 and determine that a coverage area 44-1 of the base station 12-3 overlaps the coverage area 26-1. The CAO controller 22 may then determine, based on the perimeters of the coverage area 26-1 and the coverage area 44-1, a coverage area overlapped quantity that identifies how much of the coverage area 26-1 is overlapped by the coverage area 44-1. In this example, the CAO controller 22 determines that the coverage area 44-1 overlaps 53% of the coverage area 26-1. The CAO controller 22 stores this information in the CAO structure 24.

The CAO controller 22 eventually processes the coverage area 44-1 of the base station 12-3. The CAO controller 22 determines that a coverage area 46-1 of the base station 12-4 overlaps the coverage area 44-1. The CAO controller 22 may then determine, based on the perimeters of the coverage area 46-1 and the coverage area 44-1, the coverage area overlapped quantity that identifies how much of the coverage area 44-1 is overlapped by the coverage area 46-1. In this example, the CAO controller 22 determines that the coverage area 46-1 overlaps 21% of the coverage area 44-1. The CAO controller 22 stores this information in the CAO structure 24.

The CAO controller 22 determines that the coverage area 26-1 of the base station 12-1 overlaps the coverage area 44-1. The CAO controller 22 determines that the coverage area 26-1 overlaps 55% of the coverage area 44-1. The CAO controller 22 stores this information in the CAO structure 24. The overlap information may be maintained in any suitable format, including, by way of non-limiting example, a table format such as illustrated below in Table 1.

TABLE 1

| | OVERLAPPING | PERCENTAGE |
|---|---|---|
| BASE STATION | BASE STATION | OF OVERLAP |
| BS1, CA1 | BS2, CA2 | 10 |
| BS1, CA1 | BS6, CA1 | 15 |
| BS1, CA1 | BS13, CA3 | 11 |
| BS1, CA1 | BS24, CA2 | 17 |
| BS1, CA1 | BS18, CA1 | 23 |
| BS1, CA1 | BS20, CA3 | 42 |
| BS1, CA2 | BS9, CA1 | 12 |
| BS1, CA2 | BS10, CA2 | 22 |
| BS1, CA2 | BS24, CA1 | 11 |

It is noted that, because the CAO controller 22 is a component of the computing system 14, functionality implemented by the CAO controller 22 may be attributed to the computing system 14 generally. Moreover, although for purposes of illustration the CAO controller 22 is illustrated as a single component executing on a single computing device 16 of the computing system 14, in other implementations the functionality described herein may be implemented by multiple components that may execute on the computing device 16 or may execute on a plurality of computing devices 16.

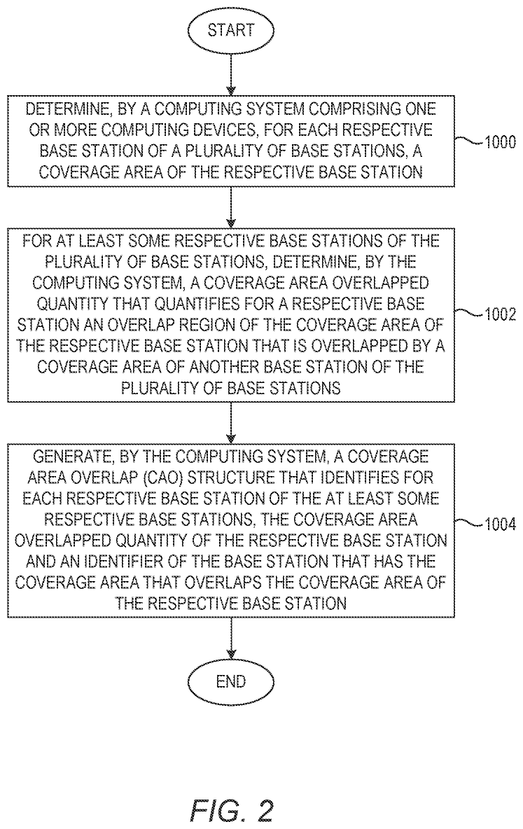

FIG. 2 is a flowchart of a method for determining coverage area overlap of the base stations 12 in proximity to one another according to one implementation. FIG. 2 will be discussed in conjunction with FIG. 1. The computing system 14 determines, for each respective base station 12 of the plurality of base stations 12, a coverage area of the respective base station 12 (FIG. 2, block 1000). The computing system 14, for at least some respective base stations of the plurality of base stations determines a coverage area overlapped quantity that quantifies for a respective base station an overlap region of the coverage area of the respective base station that is overlapped by a coverage area of another base station of the plurality of base stations (FIG. 2, block 1002). The computing system 14 generates the CAO structure 24 that identifies for each respective base station 12 of the at least some respective base stations 12, the coverage area overlapped quantity of the respective base station 12 and an identifier of the base station 12 that has the coverage area that overlaps the coverage area of the respective base station 12 (FIG. 2, block 1004).

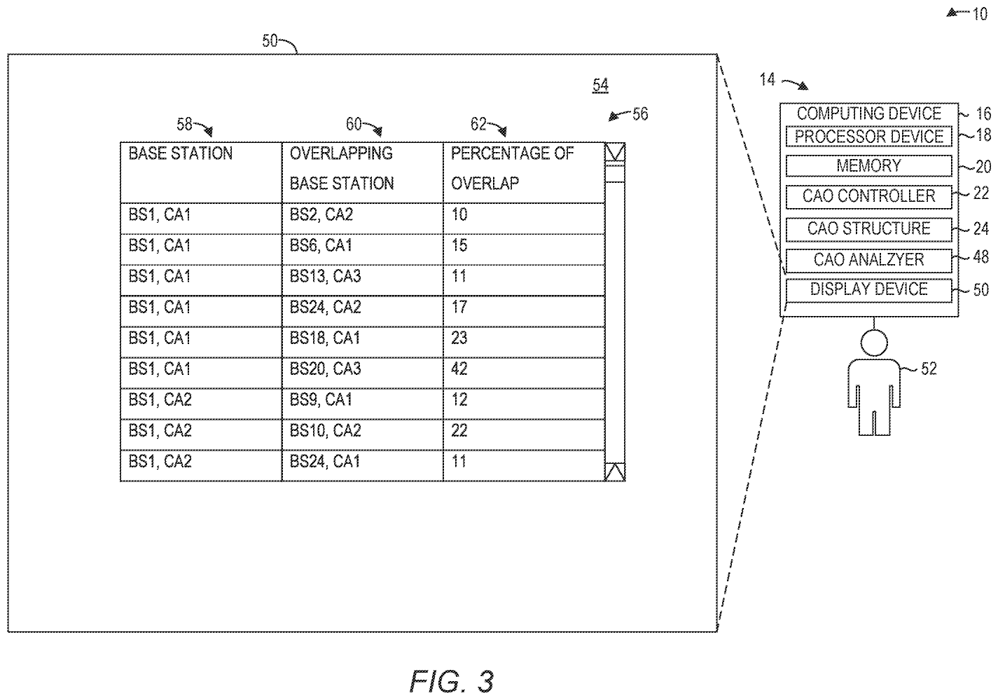

FIG. 3 is a block diagram illustrating a visualization based on the CAO structure 24 according to some implementations. The computing system 14 includes a CAO analyzer 48 that is operable to visualize aspects of the CAO structure 24 on a display device 50. While for purposes of illustration the CAO analyzer 48 is illustrated as a separate component, in other implementations the CAO analyzer 48 may be incorporated into another component, such as, by way of non-limiting example, the CAO controller 22.

In this example, an operator 52 has submitted a request to the CAO analyzer 48 to view the coverage area overlapped quantity of each of the base stations 12. In response, the CAO analyzer 48 accesses the CAO structure 24 and generates and presents user interface imagery 54 on the display device 50. The user interface imagery 54 includes a scrollable table 56 that includes a column 58 that identifies the particular base station and coverage area for each row of information. Note that the data presented in the table 56 is unrelated to the example illustrated in FIG. 1. The scrollable table 56 also includes a column 60 that identifies an overlapping base station that has a coverage area that overlaps the base station coverage area identified in the column 58, and a column 62 that identifies the amount of coverage area overlap, quantifying how much of the coverage area identified in the column 58 is overlapped by the coverage area identified in the column 60.

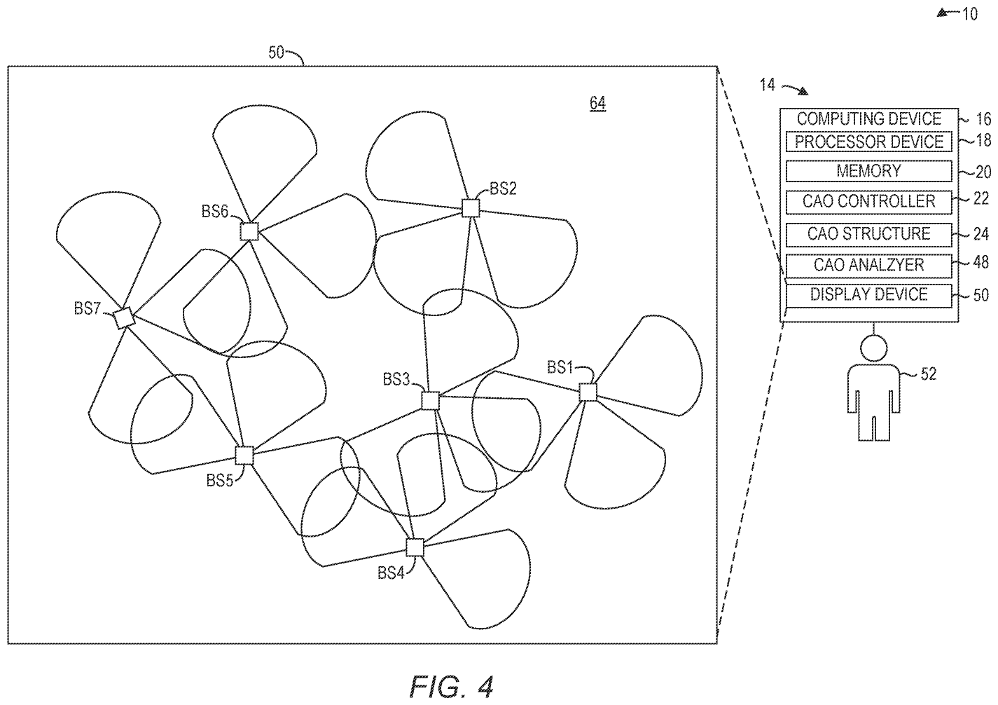

FIG. 4 is a block diagram illustrating a visualization based on the CAO structure according to another example. In this example, the operator 52 has submitted a request to the CAO analyzer 48 to view a diagram illustrating the coverage areas and coverage area overlap of the base stations 12 illustrated in FIG. 1. In response, the CAO analyzer 48 accesses the CAO structure 24 and generates and presents user interface imagery 64 on the display device 50. The user interface imagery 64 depicts the relative location of each base station 12 and the coverage areas of each base station 12.

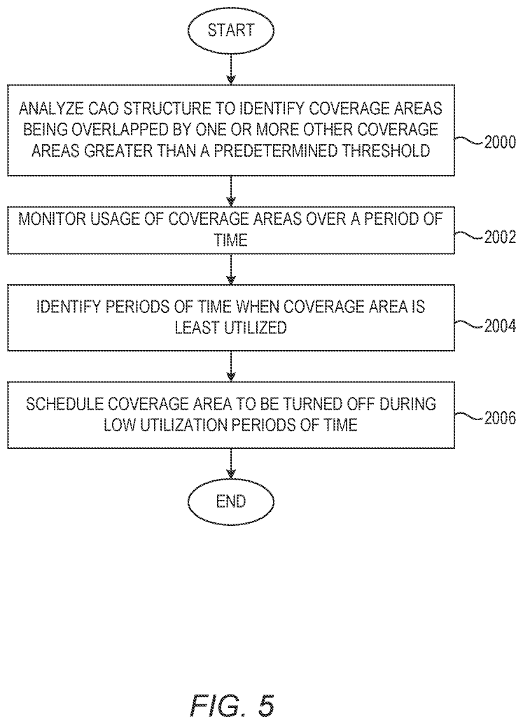

FIG. 5 is a flowchart of a method for reducing energy costs in the environment 10 illustrated in FIG. 1 based on the CAO structure 24 according to one implementation. FIG. 5 will be discussed in conjunction with FIG. 1. In this example, the computing system 14 analyzes the CAO structure 24 to identify coverage areas being overlapped by one or more other coverage areas greater than a predetermined threshold (FIG. 5, block 2000). In this example, the predetermined threshold is 70%. The computing system 14 identifies the coverage area 44-1 of the base station 12-3 as being overlapped by the coverage area 46-1 of the base station 12-4 and the coverage area 26-1 of the base station 12-1. The computing system 14 determines that the coverage area 46-1 overlaps 21% of the coverage area 44-1 and the coverage area 26-1 overlaps 55% of the coverage area 44-1.

The computing system 14 may monitor usage of the coverage area 44-1 over a period of time, such as several weeks or several months (FIG. 5, block 2002). In some implementations, as the CAO structure 24 is periodically updated as described above, the real time usage of the coverage area is stored in the CAO structure 24 along with a timestamp. The usage information may be maintained for any suitable historical duration of time, such as one week, a month, a year, or the like. In such implementations the computing system 14 need not separately monitor the usage of the coverage area 44-1 and can access the historical usage of the coverage area 44-1.

The computing system 14 may identify one or more consistent periods of time when the coverage area 44-1 is least utilized (FIG. 5, block 2004). In some implementations the computing system 14 may compare the utilization to a threshold utilization to determine whether the coverage area 44-1 is sufficiently underutilized. The computing system 14 may then schedule the coverage area 44-1 to be turned off during the one or more consistent periods of time to save energy costs of the base station 12-3 (FIG. 5, block 2006). In this manner energy costs associated with maintaining a coverage area can be reduced with little to no practical impact to mobile device users.

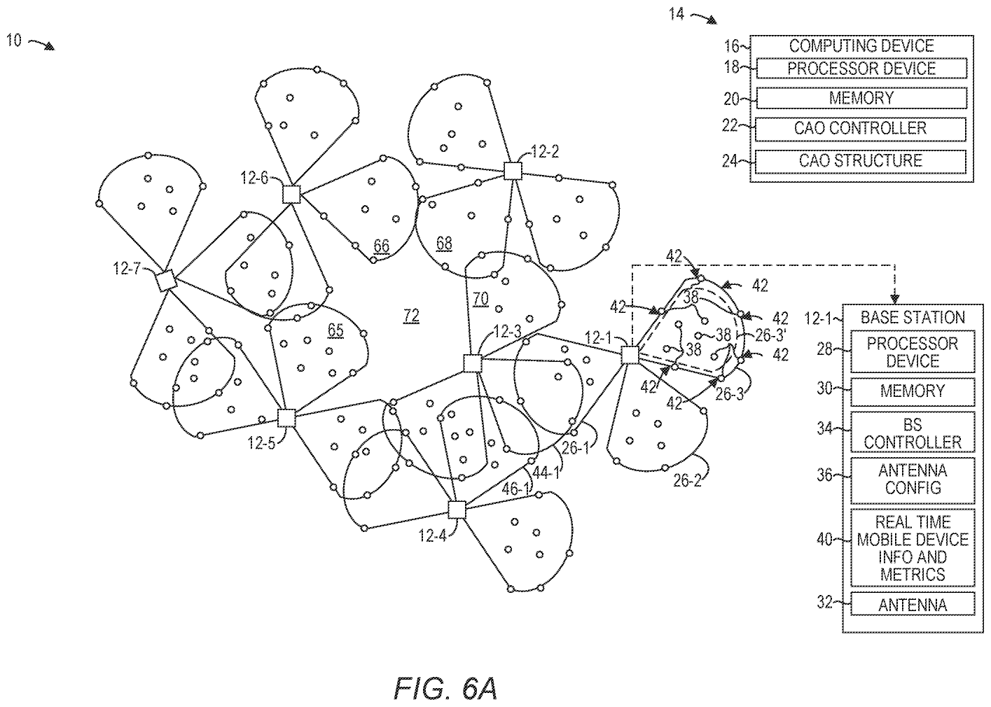

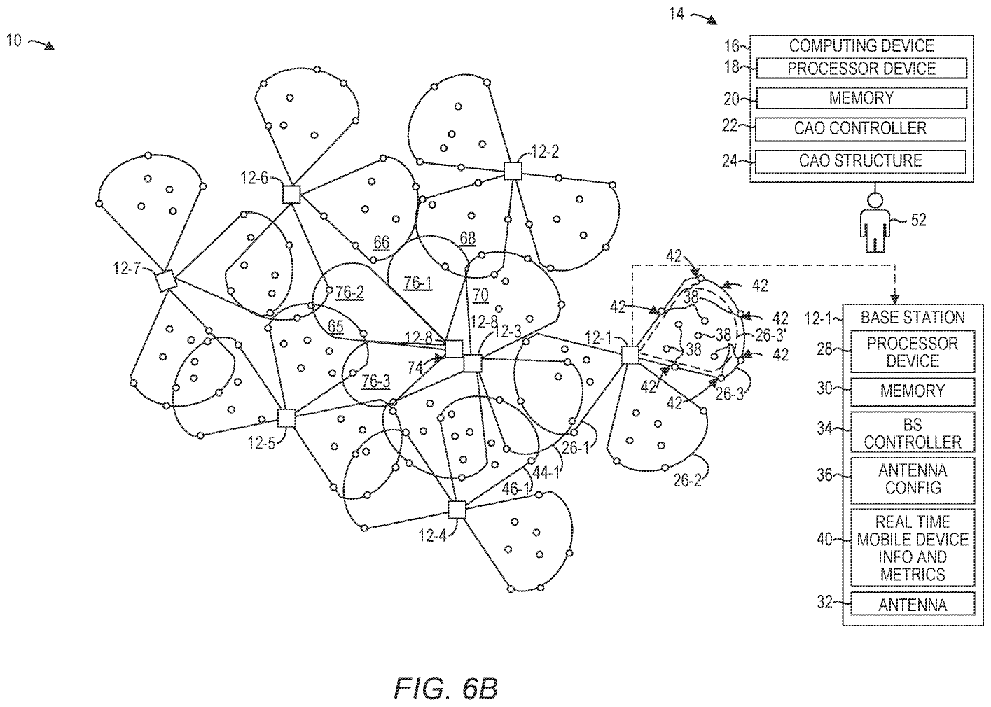

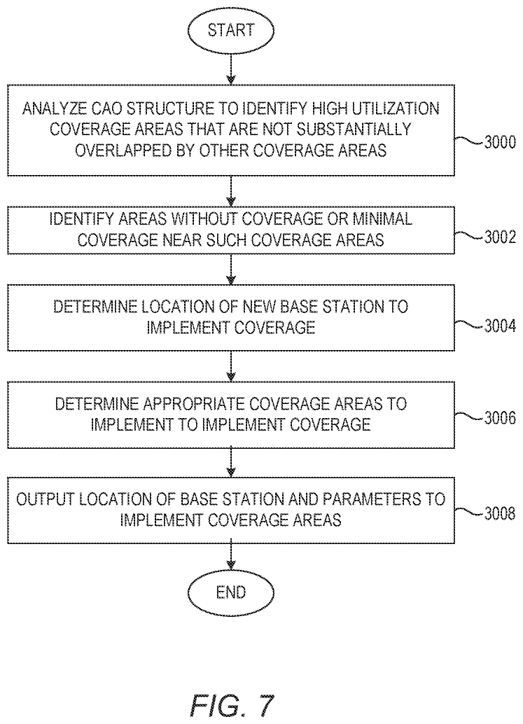

FIGS. 6A-6B are block diagrams of the environment 10 illustrated in FIG. 1 illustrating the addition of a new base station that implements three coverage areas. FIG. 7 is a flowchart of a method for determining, based on the CAO structure 24, a location of a new base station to provide coverage in an uncovered area in the environment 10 illustrated in FIG. 6A according to one implementation. FIG. 7 will be discussed in conjunction with FIGS. 6A and 6B. In this example the computing system 14 may initially identify coverage areas that have a high utilization but that are not overlapped by other coverage areas beyond a predetermined threshold (FIG. 7, block 3000). In this example, referring to FIG. 6A, the computing system 14, based on the CAO structure 24, identifies coverage areas 65, 66, 68 and 70 as coverage areas that have a high utilization but that are not substantially overlapped by other coverage areas. The computing system 14 may then determine if there are uncovered areas adjacent to such coverage areas (FIG. 7, block 3002). If so, then the coverage areas of existing base stations may not be able to be altered to cover the uncovered areas because the coverage areas of the existing base stations are not overlapped by other coverage areas, and the utilization of the existing coverage areas is already high. In this example, again referring to FIG. 6A, the computing system 14 identifies the uncovered area 72 as an uncovered area adjacent to the coverage areas.

Referring now to FIG. 6B, the computing system 14, based on the CAO structure 24, identifies a location 74 where a new base station 12-8 could be implemented to provide coverage in the uncovered area 72 (FIG. 7, block 3004). The computing system 14 determines the appropriate shape of three coverage areas 76-1, 76-2 and 76-3 suitable to substantially cover the uncovered area 72 (FIG. 7, block 3006). The computing system 14 may also determine the appropriate antenna and transmission parameters to implement the coverage areas 76-1-76-3 and output the location of the base station 12-8 and the appropriate antenna and transmission parameters for presentation to the operator 52 (FIG. 7, block 3008).

It is noted that the examples presented herein illustrate only a few of the many potential uses of the CAO structure 24. As additional examples, it is common in practice to frequently make configuration changes for network optimization, upgrades, troubleshooting, and the like. Often such changes impact not only the base station that is being maintained, but also impact coverage areas of neighbor base stations. For example any changes made to optimize traffic in one specific coverage area may impact other coverage areas as well. Analysis of the coverage areas based on the CAO structure 24 can, even prior to making any such changes, help identify how such changes will impact adjacent coverage areas.

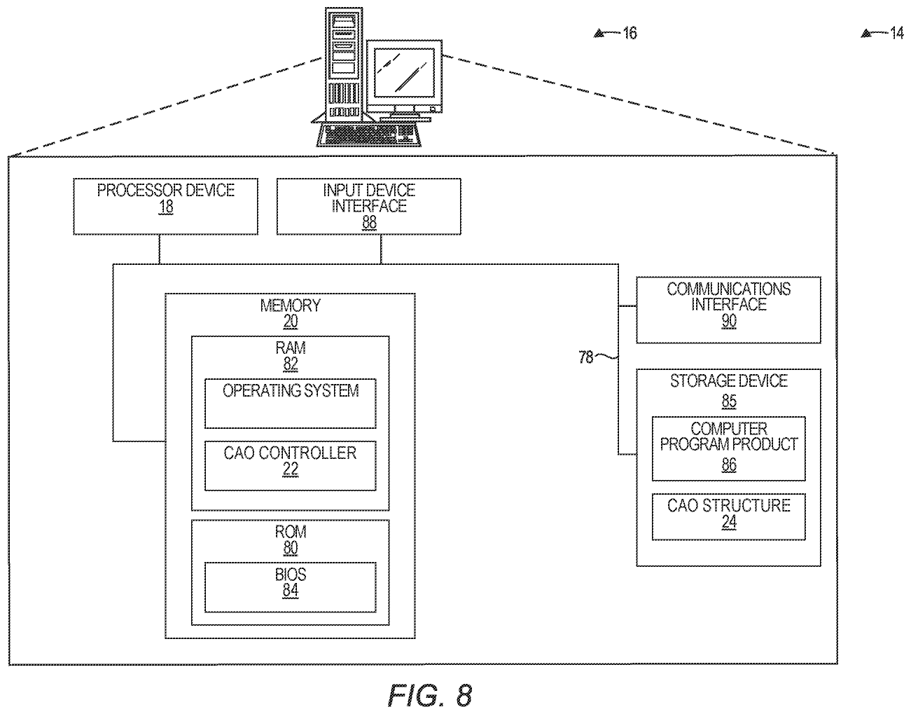

FIG. 8 is a block diagram of a computing device 16 of the computing system 14 suitable for implementing examples according to one example. The computing device 16 may comprise any computing or electronic device capable of including firmware, hardware, and/or executing software instructions to implement the functionality described herein, such as a computer server, a desktop computing device, a laptop computing device, or the like. The computing device 16 includes the processor device 18, the system memory 20, and a system bus 78. The system bus 78 provides an interface for system components including, but not limited to, the system memory 20 and the processor device 18. The processor device 18 can be any commercially available or proprietary processor.

The system bus 78 may be any of several types of bus structures that may further interconnect to a memory bus (with or without a memory controller), a peripheral bus, and/or a local bus using any of a variety of commercially available bus architectures. The system memory 20 may include non-volatile memory 80 (e.g., read-only memory (ROM), erasable programmable read-only memory (EPROM), electrically erasable programmable read-only memory (EEPROM), etc.), and volatile memory 82 (e.g., random-access memory (RAM)). A basic input/output system (BIOS) 84 may be stored in the non-volatile memory 80 and can include the basic routines that help to transfer information between elements within the computing device 16. The volatile memory 82 may also include a high-speed RAM, such as static RAM, for caching data.

The computing device 16 may further include or be coupled to a non-transitory computer-readable storage medium such as a storage device 85, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 85 and other drives associated with computer-readable media and computer-usable media may provide non-volatile storage of data, data structures, computer-executable instructions, and the like.

A number of modules can be stored in the storage device 85 and in the volatile memory 82, including an operating system and one or more program modules, such as the CAO controller 22, which may implement the functionality described herein in whole or in part. All or a portion of the examples may be implemented as a computer program product 86 stored on a transitory or non-transitory computer-usable or computer-readable storage medium, such as the storage device 85, which includes complex programming instructions, such as complex computer-readable program code, to cause the processor device 18 to carry out the steps described herein. Thus, the computer-readable program code can comprise software instructions for implementing the functionality of the examples described herein when executed on the processor device 18. The processor device 18, in conjunction with the CAO controller 22 in the volatile memory 82, may serve as a controller, or control system, for the computing device 16 that is to implement the functionality described herein.

The operator 52 may also be able to enter one or more configuration commands through a keyboard (not illustrated), a pointing device such as a mouse (not illustrated), or a touch-sensitive surface such as a display device. Such input devices may be connected to the processor device 18 through an input device interface 88 that is coupled to the system bus 78 but can be connected by other interfaces such as a parallel port, an Institute of Electrical and Electronic Engineers (IEEE) 1394 serial port, a Universal Serial Bus (USB) port, an IR interface, and the like. The computing device 16 may also include a communications interface 90 suitable for communicating with a network as appropriate or desired.

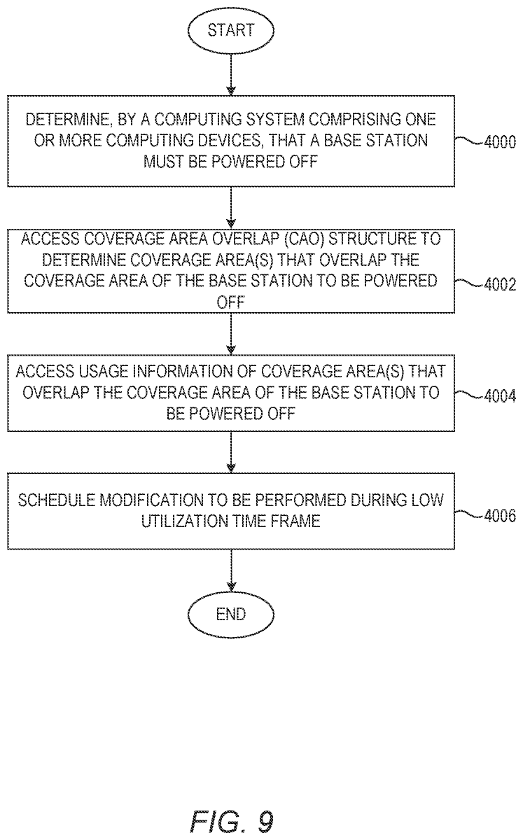

FIG. 9 is a flowchart of a method for identifying preferable timeframes to power down a base station based on overlapping coverage areas and utilization metrics of the overlapping coverage areas according to one implementation. In this example it is determined that a base station must be powered off to resolve an issue, install an upgrade, install new equipment, or the like (FIG. 9, block 4000). The CAO controller 22 accesses the CAO structure 24 to determine which base station(s) have coverage areas that overlap the coverage area of the base station to be powered off (FIG. 9, block 4002). The CAO controller 22 accesses utilization information of the coverage areas that overlap the coverage area of the base station to be powered off (FIG. 9, block 4004). The CAO controller 22 then schedules the base station to be powered off during low utilization time frames of such coverage areas (FIG. 9, block 4006). This ensures that the coverage areas can service the additional mobile devices that will seek service from the base stations when the base station is powered off. If, alternatively, the base station was powered off during high utilization times of the overlapping coverage areas, mobile devices that seek service from the base stations may be denied service, resulting in customer dissatisfaction.

Individuals will recognize improvements and modifications to the preferred examples of the disclosure. All such improvements and modifications are considered within the scope of the concepts disclosed herein and the claims that follow.

What is claimed is:

1. A method, comprising:
determining, by a computing system comprising one or more computing devices, for each respective base station of a plurality of base stations, a coverage area of the respective base station;
for at least some respective base stations of the plurality of base stations, determining, by the computing system, a coverage area overlapped quantity that quantifies for a respective base station an overlap region of the coverage area of the respective base station that is overlapped by a coverage area of another base station of the plurality of base stations; and
generating, by the computing system, a coverage area overlap (CAO) structure that identifies for each respective base station of the at least some respective base stations, the coverage area overlapped quantity of the respective base station and an identifier of the base station that has the coverage area that overlaps the coverage area of the respective base station.

2. The method of claim 1, further comprising generating, by the computing system, information that identifies a first base station of the plurality of base stations, a coverage area overlapped quantity of the first base station, and an identifier of a second base station that has the coverage area that overlaps the coverage area of the first base station.

3. The method of claim 1, further comprising generating, by the computing system, imagery that depicts a coverage area of a first base station and a coverage area of a second base station that overlaps the coverage area of the first base station.

4. The method of claim 1, wherein determining, for each respective base station of the plurality of base stations, the coverage area of the respective base station comprises receiving, from each respective base station of the plurality of base stations, coverage area information.

5. The method of claim 1, wherein determining, for each respective base station of the plurality of base stations, the coverage area of the respective base station comprises:
accessing location information that identifies a location of a first base station of the plurality of base stations;
accessing azimuth information that identifies an azimuth of an antenna of the first base station;
accessing tilt information that identifies a tilt of the antenna; and
determining the coverage area of the first base station based at least in part on the location information, the azimuth information and the tilt information.

6. The method of claim 5, further comprising:
accessing mobile device location information that identifies a plurality of locations of mobile devices being serviced by the first base station, and wherein determining the coverage area of the first base station comprises determining the coverage area of the first base station based on the location information, the azimuth information, the tilt information and the mobile device location information.

7. The method of claim 1 wherein generating the CAO structure that identifies for each respective base station of the plurality of base stations, the coverage area overlapped quantity of the respective base station and an identifier of the base station that has the coverage area that overlaps the respective base station, comprises:
determining, for a first base station of the plurality of base stations, a first coverage area;
determining, for a second base station of the plurality of base stations, a second coverage area; and
determining, a percentage of the first coverage area that is overlapped by the second coverage area.

8. The method of claim 1, wherein at least some of the base stations of the plurality of base stations are multiple sector base stations that implement a plurality of coverage areas, and further comprising:
determining, for a first multiple sector base station, a plurality of coverage areas; and
for each respective coverage area of the plurality of coverage areas determining, by the computing system, a coverage area overlapped quantity that quantifies for the respective coverage area an overlap region of the respective coverage area that is overlapped by a coverage area of another base station of the plurality of base stations.

9. The method of claim 1, further comprising:
accessing, by the computing system, the CAO structure;
based on the CAO structure, identifying, by the computing system, a non-covered area that is not included in any coverage area of the plurality of base stations;
based on the CAO structure, identifying, by the computing system, a location of an additional base station that, if implemented, can provide coverage in the non-covered area; and
outputting information identifying the location of the additional base station.

10. The method of claim 9, further comprising:
determining, by the computing system, based on the CAO structure, a multi-sector antenna pattern of the additional base station; and
outputting, by the computing system, information identifying parameters of the multi-sector antenna pattern.

11. The method of claim 1, further comprising:
accessing, by the computing system, the CAO structure;
determining, by the computing system, that a first base station has a first coverage area overlapped by coverage areas of one or more second base stations above a coverage area overlap threshold;
determining, by the computing system, that the first coverage area provides service to a quantity of mobile stations below a predetermined threshold; and
in response to determining that the first base station has the first coverage area overlapped by the coverage areas of the one or more second base stations above the coverage area overlap threshold and determining that the coverage area provides service to the quantity of mobile stations below the predetermined threshold, powering down the first coverage area.

12. A computing system, comprising:
one or more computing devices operable to:
determine, for each respective base station of a plurality of base stations, a coverage area of the respective base station;
for at least some respective base stations of the plurality of base stations, determine a coverage area overlapped quantity that quantifies for a respective base station an overlap region of the coverage area of the respective base station that is overlapped by a coverage area of another base station of the plurality of base stations; and
generate a coverage area overlap (CAO) structure that identifies for each respective base station of the at least some respective base stations, the coverage area overlapped quantity of the respective base station and an identifier of the base station that has the coverage area that overlaps the coverage area of the respective base station.

13. The computing system of claim 12, wherein the one or more computing devices are further operable to generate imagery that depicts a coverage area of a first base station and a coverage area of a second base station that overlaps the coverage area of the first base station.

14. The computing system of claim 12, wherein to determine, for each respective base station of the plurality of base stations, the coverage area of the respective base station, the one or more computing devices are further operable to:
access location information that identifies a location of a first base station of the plurality of base stations;
access azimuth information that identifies an azimuth of an antenna of the first base station;
access tilt information that identifies a tilt of the antenna; and
determine the coverage area of the first base station based at least in part on the location information, the azimuth information and the tilt information.

15. The computing system of claim 12, wherein the one or more computing devices are further operable to:
access the CAO structure;
based on the CAO structure, identify a non-covered area that is not included in any coverage area of the plurality of base stations;
based on the CAO structure, identify a location of an additional base station that, if implemented, can provide coverage in the non-covered area; and
output information identifying the location of the additional base station.

16. The computing system of claim 12, wherein the one or more computing devices are further operable to:
access the CAO structure;
determine that a first base station has a first coverage area overlapped by coverage areas of one or more second base stations above a coverage area overlap threshold;
determine that the first coverage area provides service to a quantity of mobile stations below a predetermined threshold; and
in response to determining that the first base station has the first coverage area overlapped by the coverage areas of the one or more second base stations above the coverage area overlap threshold and determining that the coverage area provides service to the quantity of mobile stations below the predetermined threshold, power down the first coverage area.

17. A non-transitory computer-readable storage medium that includes executable instructions to cause one or more computing devices to:
determine, for each respective base station of a plurality of base stations, a coverage area of the respective base station;
for at least some respective base stations of the plurality of base stations, determine a coverage area overlapped quantity that quantifies for a respective base station an overlap region of the coverage area of the respective base station that is overlapped by a coverage area of another base station of the plurality of base stations; and
generate a coverage area overlap (CAO) structure that identifies for each respective base station of the at least some respective base stations, the coverage area overlapped quantity of the respective base station and an identifier of the base station that has the coverage area that overlaps the coverage area of the respective base station.

18. The non-transitory computer-readable storage medium of claim 17, wherein the instructions are further operable to cause the one or more computing devices to generate imagery that depicts a coverage area of a first base station and a coverage area of a second base station that overlaps the coverage area of the first base station.

19. The non-transitory computer-readable storage medium of claim 17, wherein to determine, for each respective base station of the plurality of base stations, the coverage area of the respective base station, the instructions are further operable to cause the one or more computing devices to:
access location information that identifies a location of a first base station of the plurality of base stations;
access azimuth information that identifies an azimuth of an antenna of the first base station;
access tilt information that identifies a tilt of the antenna; and
determine the coverage area of the first base station based at least in part on the location information, the azimuth information and the tilt information.

20. The non-transitory computer-readable storage medium of claim 17,
wherein the instructions are further operable to cause the one or more computing devices to:
access the CAO structure;
based on the CAO structure, identify a non-covered area that is not included in any coverage area of the plurality of base stations;
based on the CAO structure, identify a location of an additional base station that, if implemented, can provide coverage in the non-covered area; and
output information identifying the location of the additional base station.
